(19) United States
(12) Patent Application Publication
(10) Pub. No.: US 2015/0083295 A1
(43) Pub. Date: Mar. 26, 2015

(54) WHEEL ARCH AND WHEEL

(71) Applicant: Benito RESA RODRIGO, (US)

(72) Inventor: Benito Resa Rodrigo, Arguedas (ES)

(21) Appl. No.: 14/397,739

(22) PCT Filed: Apr. 5, 2013
(86) PCT No.: PCT/ES2013/070223

§ 371 Date: Oct. 29, 2014

(30) Foreign Application Priority Data
Apr. 30, 2012 (ES) P201230648

(51) Int. Cl. B60C 7/08; B60C 11/02; B60C 7/24

(52) U.S. Cl. CPC B60C 7/08; B60C 7/24; B60C 11/02
USPC 152/306

(57) ABSTRACT

The invention relates to a wheel arch to be coupled to a tyre (4) of a wheel, that has a liner (1) to go around a tread, a frame (2) for supporting the liner (1) and providing rigidity to the wheel arch, and fixing means for fixing the frame (2) to the tyre (4). The invention also relates to a wheel comprising various wheel arches of the above-mentioned type.

### FIELD OF THE INVENTION

Wheel arch and wheel for the automotive sector and agricultural machinery such as tractors and harvesters, which may be used for the cultivation of rice, corn, and cereals in general.

### STATE OF THE ART

Within the automotive sector, we have an area with particular characteristics: the agricultural sector.

One problem that has been the detected is the need to adapt the tread surface of agricultural and industrial vehicles to the characteristics of the soil, which vary between muddy and unstable surfaces in rice fields to the hard and rough surfaces of paved roads.

This need is justified by the high cost of repairing a full pneumatic in terms of cost and time, the high degradation thereof with the friction with the pavement or the damages caused to paved roads when the tread surface is made of iron.

Having detected this problem, the invention proposes a solution that, described very briefly, comprises the division of the rolling liner into easily exchangeable modules, the liner modules being designed for each type of surface as well. This solution improves the adherences, reliability, safety, and transformation of the wheel for the different types of soil. Another advantage is the fact that they are not pressurized pneumatics, with which the possibility of punctures is prevented and the use of rubber resources is increased.

Tractors and harvesters for the cultivation of rice and corn currently use caterpillars for harvesters, and only iron wheels for tractors, which have iron pegs and cannot be driven on roads or highways because they break the road and tar. In addition, the hammering produced in the tread causes breakdowns and disruptions of the tractors, and at the end of the day, it is easy for the back of the driver to be affected. Some tractors have twin wheels in the rear shaft, but they are welded or screwed, that is to say, they are fixed, and made of iron. Therefore, the tractor must be transported in cars and continue to experience the same inconveniences than in a conventional wheel (their thickness is fixed, the cars are not certified and are not covered by insurance in the case of an accident, etc.).

US2009/0095389 discloses a pneumatic system that includes a cylindrical metal edge with an external surface and a plurality of segments of solid pneumatics. Each one of the pneumatic segments has at least one track and is connected to an assembly plate. The assembly plates are circumferentially located on the external surface of the rim. The pneumatic system can be used in an off-earth moving machine, such as in a dragging and raking device or in another type of device.

CN201390090Y discloses a repairable and reusable modularized pneumatic with convenient installation, simple manufacture and low manufacturing cost. The pneumatic comprises a steel ring of the pneumatic and a rim of a wheel, and is characterized in that the flanges are symmetrically arranged in the circumferential part in two sides of the steel ring of the pneumatic. The pneumatic also comprises exchangeable rubber pneumatic plates with an identical shape that are assembled in equidistant intervals along the peripheral surface of the steel ring of the pneumatic. The shock-absorption, collision resistance, and puncture resistance features are superior than the features of solid pneumatics and air-filled pneumatics, and the pneumatic is appropriate for use in military motor vehicles and vehicles transporting heavy cargo in areas with irregular terrain.

U.S. Pat. No. 1,235,597A discloses a wheel with separable elastic blocks. The wheel comprises an annular rim plate on which is seated a supplemental rim plate configured to hold the tire blocks, wherein the tire blocks may be taken off and replaced by fastening means.

### DESCRIPTION OF THE INVENTION

The invention relates to wheels for vehicles such as automobiles, tractors, harvesters or other types of agricultural machinery intended for the cultivation of rice, corn or cereals. The wheels are covered with rubber modules. This way, sufficient shock-absorption is obtained to move from one plot of land to another without the need to put the tractor in cars to be moved, while also preventing back discomfort for the driver.

Some of the advantages of the wheels of the invention are the following:
The tractors do not need to be put in cars to be moved;
Adaptability to different terrains: dry, muddy, etc.;
Shock-absorption, thereby preventing breakdowns and back discomfort for the driver;
Lower costs with respect to liners, because only the damaged piece is removed without the need for a jack. In fact, the vehicle can keep working with the broken piece until the end of the day;
Flexibility for the placement of modules with different drawings and liner pegs: for rice, shovel-type pegs; for road works, smooth modules; for places covered in ice and snow, pegs with nails or spikes;
The greasing means can be used to clean the wheel arch or the entirety of the wheel without the need to disassemble the arch or the wheel: by increasing the pressure in the greasing means, the greasing element pushes the elements that could be introduced into the cavities of the arch or wheel or cause an abnormal wear and tear in the arch or wheel, outwards.

### BRIEF DESCRIPTION OF THE DRAWINGS

Next, a series of drawings will be described in brief, which help to understand the invention better and are expressly related to an embodiment of said invention presented as a non-limitative example thereof.

FIG. 1 shows an exploded view of the wheel arch of a tractor wheel for the cultivation of rice and the elements making up the arch.

FIG. 1.1A shows a perspective of the wheel arch of FIG. 1.

FIG. 1.1B shows a lateral view of the wheel arch of FIG. 1.

FIG. 1.1C shows a diameter cut of a wheel comprising the wheel arch of FIG. 1 on the rim.

FIG. 2 shows a perspective of the frame.

FIG. 3 shows a wheel arch having a liner to roll on a rolling surface.

FIG. 4 shows a detail of a wheel arch for the sowing and trade of rice.

FIG. 5 shows an embodiment of the invention where two wheel arches are fixed to the rim by means of screws.

FIG. 6 shows additional elements of the grip system of the wheel arches to the rim.

FIG. 7 shows joined wheel arches and a grease circuit indicated with arrows, as well as several components of the invention.

FIG. 8 shows an embodiment of the invention where the liners of the wheel arches and the liner supplement show a shape to be applied to private cars.

FIG. 9 shows an exploded view where the components of an embodiment of the invention can be observed.

FIG. 10 is a detailed view of FIG. 9.

FIG. 11 shows a second embodiment of the invention, where the fixing means of the wheel arch comprise a central screw and a spring-shaped plate.

FIG. 12 shows a third embodiment of the invention, where the fixing means of the wheel arch comprise a connecting ring and retaining means.

FIG. 13 shows a front tractor wheel with eight five-peg pieces.

FIG. 14 shoes a twin tractor or harvester wheel for the cultivation and harvesting of rice. In this case it comprises 20 pieces.

### DETAILED DESCRIPTION OF AN EMBODIMENT

Each arch in its entirety may be considered as an anti-vibration silent block, configured to be linked to an adjacent piece. In an embodiment of the invention, the arches measure Pi 100 mm and are configured to be fastened to the rim (4) with four screws on each side, which pass through elongated holes of the components of the arch. These elongated holes allow for some flexibility of the components of the arch; the arch can be deformed by stretching when the wheel rests on the terrain through the arch. In order to reduce the number of screws necessary to fix all the arches, the size of the arches can be doubled to 2 Pi 100 mm. If the diameter of the wheel so requires it, arches with different sizes can be used.

Given that the arch of a circumference corresponding to an angle is related by means of the following expression:

s=θ·r

where:

s=arch length
θ=angle in rad (radians)
r=circumference radius

Some examples of the invention are included, where the angle for the entire wheel is 2 Pi radians:
2,000 mm-diameter wheel (1,000 mm radius):

s=2Pi·1,000mm=6,283.2mm

Selecting the number of pieces to make up the entire arch of the wheel:

20 314.16 mm-pieces
10 628.32 mm-pieces
1,900 mm-diameter wheel (950 mm radius):

s=2Pi·950mm=5,969.04mm

Selecting the number of pieces to make up the entire arch of the wheel:

19 314.16 mm-pieces, or
9 628.32 mm-pieces and 1 314.16 mm-piece
1,800 mm-diameter wheel (900 mm radius):

s=2Pi·900mm=5,654.88mm

Selecting the number of pieces to make up the entire arch of the wheel:

18 314.16 mm-pieces, or
9 628.32 mm-pieces.

With reference to the figures, FIG. 1 shows an exploded view of the wheel arch of a tractor wheel and the elements making up the arch:
Peg-shaped rubber liner (1) to roll on a rolling surface;
Frame (2) in the form of a metal leaf spring; iron-steel;
Rubber seat (3) configured to settle in the rim (4) of the wheel.

FIG. 1.1A shows a perspective of the wheel arch of FIG. 1.

FIG. 1.1B shows a lateral view of the wheel arch of FIG. 1.

FIG. 1.1C shows a diameter cut of a wheel comprising the wheel arch of FIG. 1 on the rim (4).

FIG. 2 shows a perspective of the frame (2). The frame (2) or metal leaf spring can be thicker or thinner according to the weight of the vehicle. The frame (2) comprises:
A plurality of perforations (20) configured for the liner (1) and the seat (3) to be joined when vulcanized due to the leakage of the vulcanization;
A plurality of fixing slots (21) configured to allow a passage of grip screws;
A greasing hole (22) configured to allow a passage of grease and prevent the wear and tear of the rubber with its movement.

FIG. 3 shows a wheel arch having a liner (1) configured to circulate on roads. In an embodiment of the invention, this type of liner (1) is valid to be used in cars or trucks. The liner (1) illustrated in FIG. 3 corresponds to a private car.

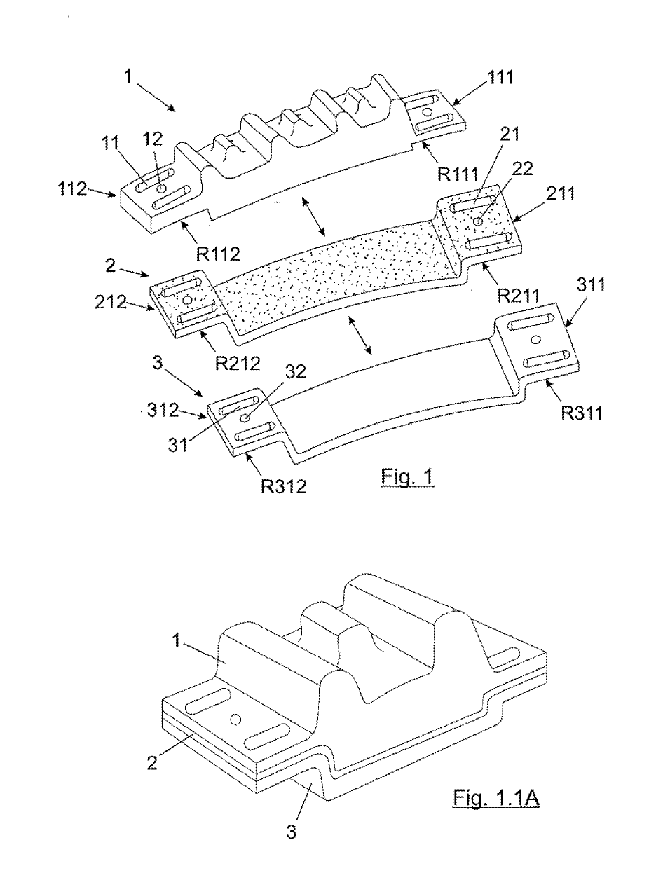

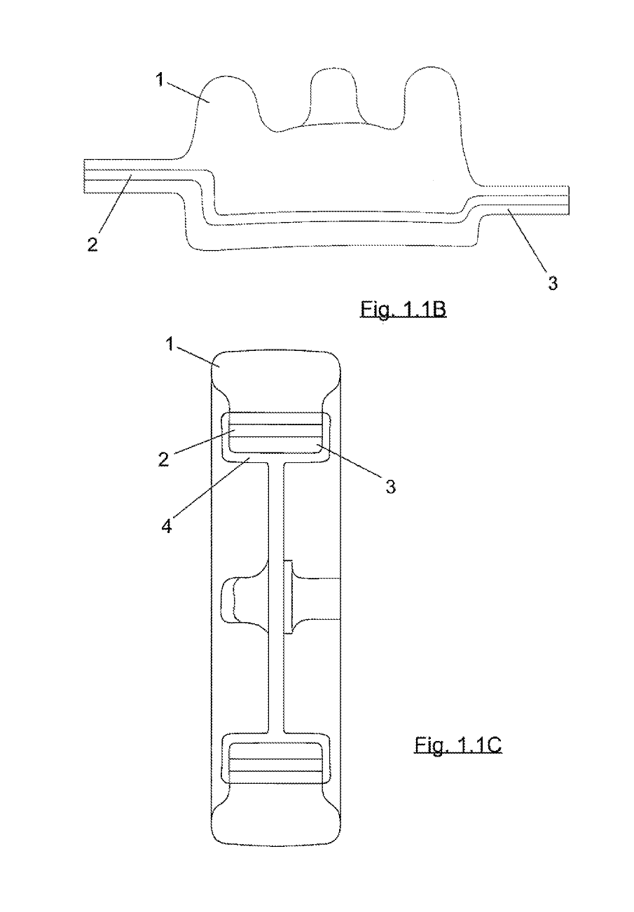

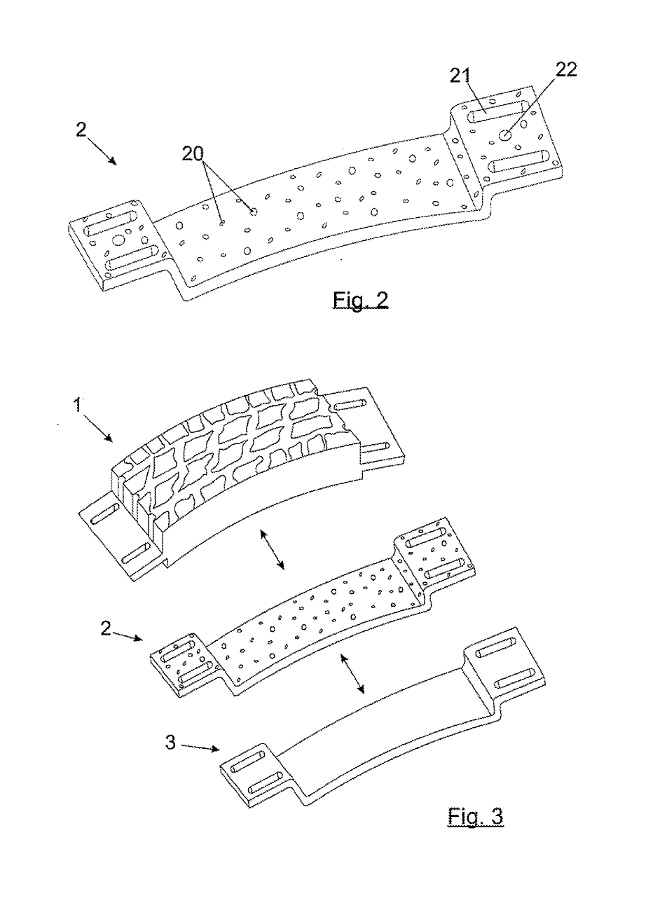

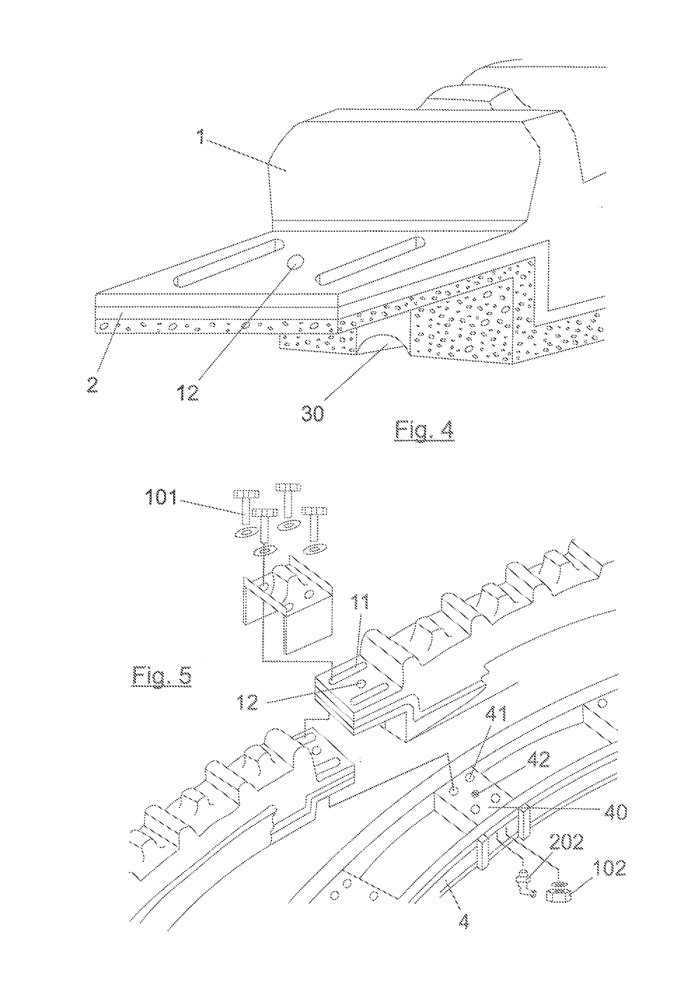

FIG. 4 shows a detail of a wheel arch for the cultivation and trade of rice.
Rubber peg of the liner (1);
Configured channel (30) of the seat (3) to allow a passage of grease;
Frame (2);
Greasing hole (12).

FIG. 5 shows an embodiment of the invention where two wheel arches are fixed to the rim (4) by means of screws (101), which fix both arches to an inverted U (40) with holes (41), which may be welded to the rim (4). A grease nipple (202) and the nuts (102) are also shown in FIG. 5.

FIG. 6 shows additional elements of a grip system of the wheel arches to the rim (4);
a liner supplement (110) having an anti-vibrations peg vulcanized to the closing element (100);
positioning means (43), which are fastening pillars in an embodiment of the invention to avoid the angular mobility of the closing element (100) with respect to the rim (4).

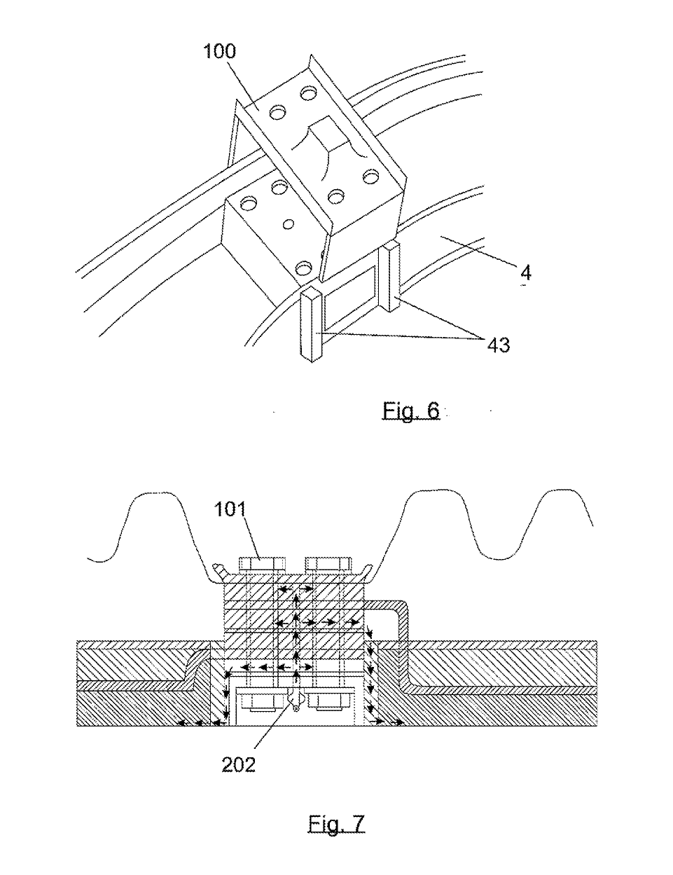

FIG. 7 shows joined wheel arches and a grease circuit indicated with arrows, as well as several components of the invention:
grease nipple (202);
screws (101);
closing element (100);
positioning means (43) to avoid angular mobility.

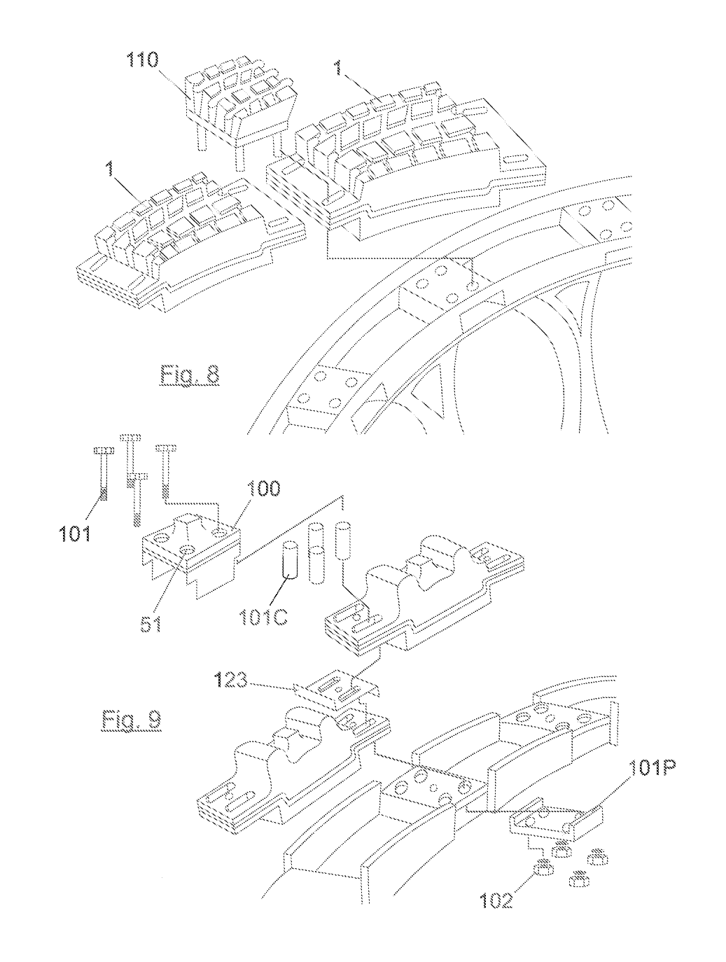

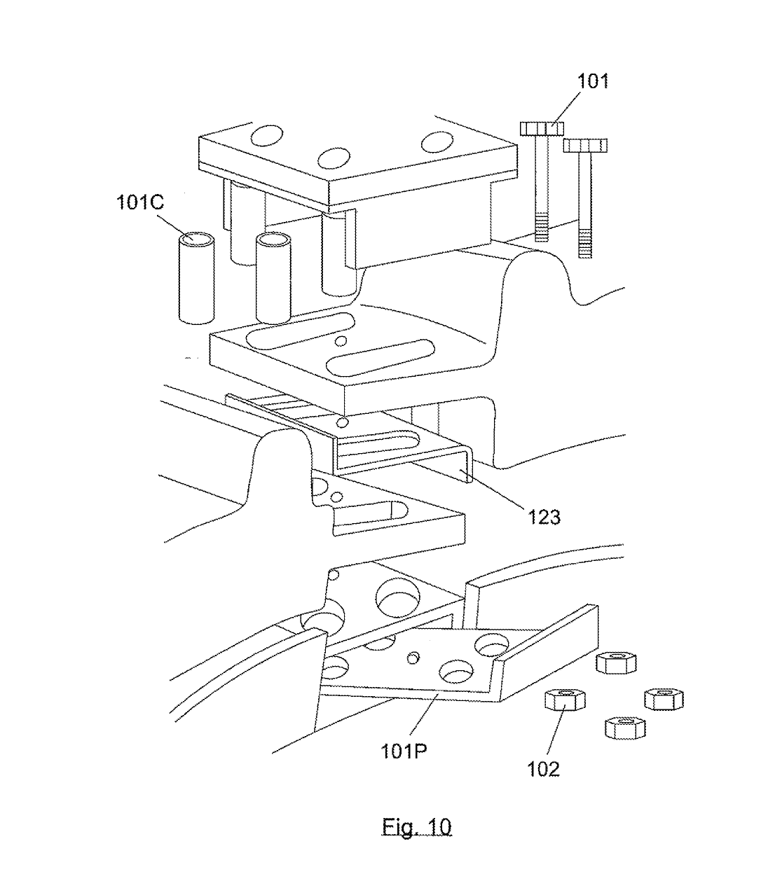

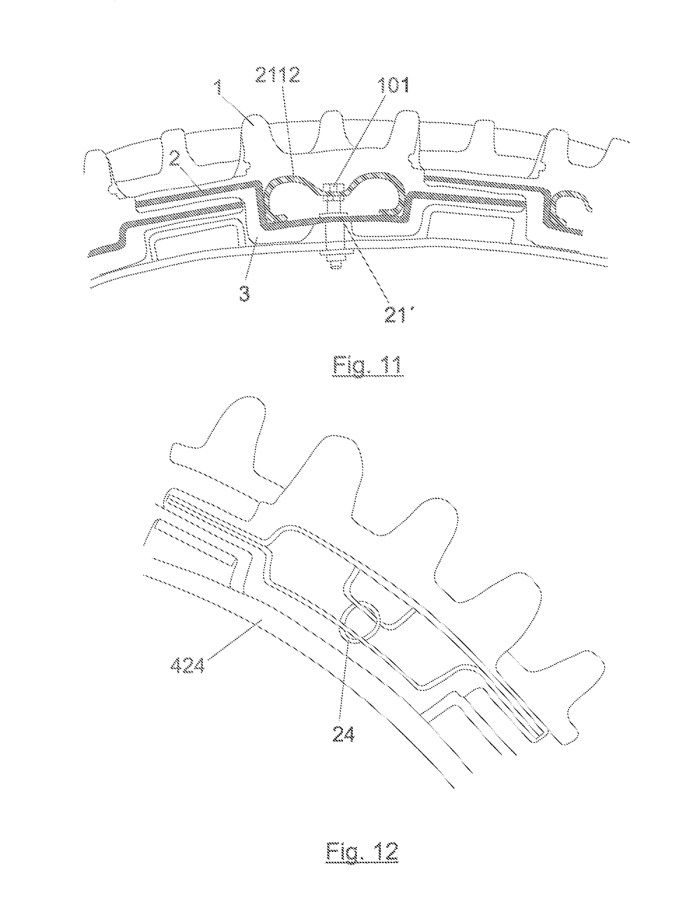

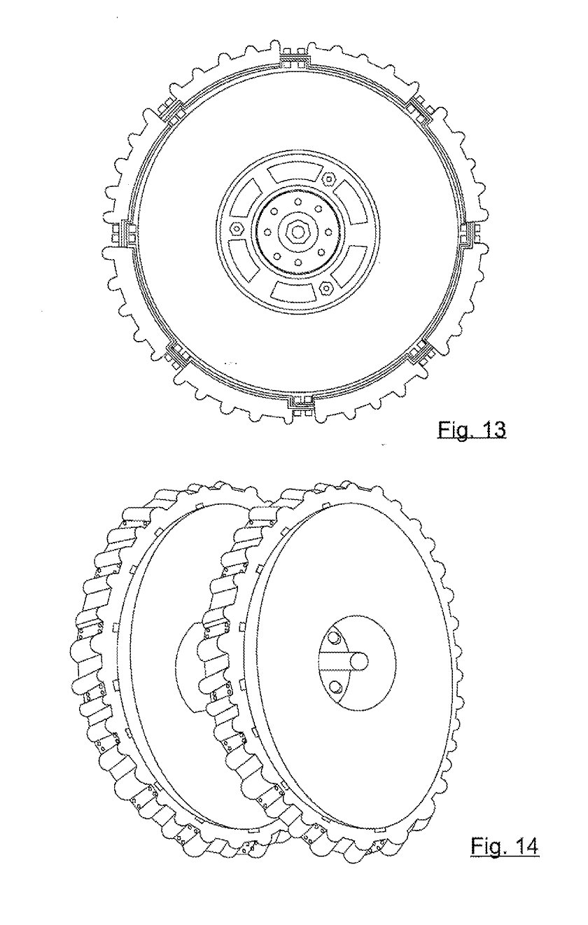

FIG. 8 shows an embodiment of the invention where the liners (1) of the wheel arches and the liner supplement (110) show a shape to be applied to private cars.

A first aspect of the invention relates to a wheel arch configured to be coupled to a rim (4) of a wheel that comprises:

1a) a liner (1) configured to roll on a rolling surface;

1b) a frame (2) configured to support the liner (1) and providing rigidity to the wheel arch; and

1c) fixing means for fixing the frame (2) to the rim (4).

According to other characteristics of the invention:

2a) The frame (2) is covered by the liner (1) without an air chamber between the frame (2) and the liner (1). That is to say, there is no intermediate air chamber between the frame (2) and the liner (1).

3. The wheel arch comprises:

3a) a seat (3) configured to settle in the rim (4) and provide shock-absorption between the frame (2) and the rim (4);

3b) fastening means of the seat (3) between the frame (2) and the rim (4).

4. The fixing means comprise:

4a) an initial section (111, 211, 311) in a first extremity of the arch;

4b) a final section (112, 212, 312) in a second extremity of the arch opposite the first extremity; where:

4c) the initial section (111, 211, 311) has an initial radius (R111, R211, R311);

4d) the final section (112, 212, 312) has a final radius (R112, 8212, R312);

4e) the final radius (R112, R212, R312) is greater than the initial radius (R111, R211, R311) and the initial radius (R111, 8211, R311) and the final radius (R112, 8212, R312) are configured such that the initial section (111, 211, 311) and the final section (112, 212, 312) overlap each other when two arches are placed in a consecutive manner.

5. The wheel arch comprises an intermediate sheet (123) in a location selected between the initial section (111, 211, 311) and the final section (112, 212, 312). The intermediate sheet (123) is configured in order to avoid direct contact between a liner (1) and a seat (3) when two arches are placed in a consecutive manner.

5′. The wheel arch comprises a fastening sheet (101P) between the rim (4) and the nuts (102), configured to avoid direct contact between the nuts (102), which may be provided with washers, and the rim (4).

6a. The fixing means comprise, in the liner (1), a first fixing hole (11) configured to allow a passage of a grip screw (101).

7a). The fixing means comprise, in the frame (2), a second fixing hole (21) configured to allow a passage of a grip screw (101).

8a). The fastening means comprise, in the seat (3), a third fixing hole (31) configured to allow a passage of a grip screw (101).

9. The fixing holes (11, 21, 31) comprise slotted openings in the initial section (111, 211, 311) and in the final section (112, 212, 312) configured to facilitate the assembly/disassembly of the arch and an operation in the form of leaf spring during the use of the arch. According to one of the definitions of leaf spring, a leaf spring is a spring in the shape of an arch, built with several overlapping elastic steel sheets similar to the ones used in some vehicle suspension systems. Thus, when the arch is being used, the fixing holes (11, 21, 31) allow the arch to operate as a leaf spring, that is to say, the arch works while being bent when the wheel is rolling on a surface.

10. According to a second embodiment of the invention, the fixing means comprise:

10a) in the frame (2), a central fixing hole (21′) configured to allow a passage of a grip screw (101);

10b) a curved plate in the form of a spring or clip (2112), configured to press the frame (2) against the rim (4) by means of a grip screw (101).

11. According to a third embodiment of the invention, the fixing means comprise, in the frame (2), a connecting ring (24) configured to be connected to retaining means (424).

12. The wheel arch comprises:

12a) greasing means configured to grease a layer selected from the liner (1), the frame (2), the seat (3) and combinations thereof

13a) The greasing means comprise, in the liner (1), a first greasing hole (12) configured to allow a passage of grease.

14a) The greasing means comprise, in the frame (2), a second greasing hole (22) configured to allow a passage of grease.

15a) The greasing means comprise, in the seat (3), a third greasing hole (32) configured to allow a passage of grease.

16a) The frame (2) is configured in the form of a leaf spring to provide shock-absorption by means of a controlled bending deformation of the frame (2).

16′. The liner (1) has a peg shape.

16″. The liner (1), the seat (3), or both, are made of rubber.

16′″. The frame (2) is made of iron or steel.

17. A second aspect of the invention relates to a wheel comprising a plurality of wheel arches as described above, where the arches are configured to make up a tread of the wheel. According to one of the definitions of liner, a liner is a strip that protects the chamber of the pneumatics exteriorly and suffers the friction with the ground.

According to other characteristics of the invention:

18a) the rim (4) comprises a rim supplement (40) configured to define a location of a wheel arch on the rim (4). The rim supplement (40) may be a rib in the rim where a rim arch has a greater radius than the rest of the rim.

19a) The fixing means comprise, in a location selected between the rim (4) and the rim supplement (40), a fourth fixing hole (41), configured to allow a passage of a grip screw (101).

20a) The greasing means comprise, in a location selected between the rim (4) and the rim supplement (40), a fourth greasing hole (42), configured to allow a passage of grease.

21. The wheel comprises:

21a) a closing element (100) configured to be coupled on two consecutive arches to collaborate with the fixing of the two arches on the rim (4).

22. The wheel comprises:

22a) positioning means (43) configured to constrain a relative movement between the closing element (100) and the rim (4).

23a) The closing element (100) comprises a liner supplement (110) configured to provide continuity to the tread between the liners (1) of two consecutive arches.

24a) The fixing means comprise, in the closing element (100), a plurality of fifth fixing holes configured to allow a passage of grip screws (101).

25a) The fixing means comprise a plurality of nuts (102) configured to thread with the grip screws (101) and fix components of the wheel to the rim (4). These nuts (102) may be located in a location selected between the rim (4) and the inverted U (40). The nuts (102) allow favouring the pressing of the components of the wheel.

26. The wheel comprises a plurality of caps (101C) configured to prevent the contact of the grip screws (101) and the fixing holes (11, 21, 31, 41).

27. The wheel:

27a) comprises a stopper sheet (101P) configured to delimit a radial penetration of the caps (101C) into the wheel. The stopper sheet (101P) is located in a smaller stopper radius than the initial radius (R111, 8211, R311);

27b) the fixing means comprise, in the stopper sheet, a fifth fixing hole (51) configured to allow a passage of a grip screw (101). The fifth fixing holes (51) are also configured such that they are not pierced by the caps (101C) and the radial penetration of the caps (101C) into wheel is limited.

28. The wheel comprises:

28a) a grease nipple (202) configured to supply grease through a greasing hole selected from the first greasing hole (12), the second greasing hole (22), the third greasing hole (32), the fourth greasing hole (42) and combinations thereof

29. The wheel comprises retaining means (424) configured to be connected to a connecting ring (24) of the frame (2).

1. Wheel arch configure to be coupled to a tyre (4) of a wheel, characterized in that it comprises:
1a) a liner (1) configured to roll around a tread;
1b) a frame (2) for supporting the liner (1) and providing rigidity to the wheel arch; and
1c) fixing means for fixing the frame (2) to the tyre (4).

2. Wheel arch according to claim 1, characterized in that:
2a) the frame (2) is covered by the liner (1) without an air chamber between the frame (2) and the liner (1).

3. Wheel arch according to any one of the claims 1-3, characterized in that it comprises:
3a) a seat (3) configured to settle in the tyre (4) and provide shock-absorption between the frame (2) and the tyre (4);
3b) fastening means of the seat (3) between the frame (2) and the tyre (4).

4. Wheel arch according to any one of the claims 1-3, characterized in that the fixing means comprise:
4a) an initial section (111, 211, 311) in a first extremity of the arch;
4b) a final section (112, 212, 312) in a second extremity of the arch opposite the first extremity;
where:
4c) the initial section (111, 211, 311) has an initial radius (R111, R211, R311);
4d) the final section (112, 212, 312) has a final radius (R112, 8212, R312);
4e) the final radius (R112, 8212, R312) is greater than the initial radius (R111, R211, R311) and the initial radius (R111, 8211, R311) and the final radius (R112, R212, R312) are configured such that the initial section (111, 211, 311) and the final section (112, 212, 312) overlap each other when two arches are placed in a consecutive manner.

5. Wheel arch according to claim 4, characterized in that it comprises an intermediate sheet (123) in a location selected between the initial section (111, 211, 311) and the final section (112, 212, 312).

6. Wheel arch according to any one of the claims 1-5, characterized in that:
6a) the fixing means comprise, in the liner (1), a first fixing hole (11) configured to allow a passage of a grip screw (101).

7. Wheel arch according to any one of the claims 1-6, characterized in that:
7a) the fixing means comprise, in the frame (2), a second fixing hole (21) configured to allow a passage of a grip screw (101).

8. Wheel arch according to any one of the claims 3-7, characterized in that:
8a) the fastening means comprise, in the seat (3), a third fixing hole (31) configured to allow a passage of a grip screw (101).

9. Wheel arch according to claim 8, characterized in that: the fixing holes (11, 21, 31) comprise slotted openings in the initial section (111, 211, 311) and in the final section (112, 212, 312) configured to facilitate the assembly/disassembly of the arch and an operation in the form of leaf spring during the use of the arch.

10. Wheel arch according to any one of the claims 7-9, characterized in that the fixing means comprise:
10a) in the frame (2), a central fixing hole (21′) configured to allow a passage of a grip screw (101);
10b) a curved plate in the form of a spring or clip (2112), configured to press the frame (2) against the tyre (4) by means of a grip screw (101).

11. Wheel arch according to any one of the claims 1-10, characterized in that the fixing means comprise, in the frame (2), a connecting ring (24) configured to be connected to retaining means (424).

12. Wheel arch according to any one of the claims 3-11, characterized in that it comprises:
12a) greasing means configured to grease a layer selected from the liner (1), the frame (2), the seat (3) and combinations thereof.

13. Wheel arch according to claim 12, characterized in that:
13a) the greasing means comprise, in the liner (1), a first greasing hole (12) configured to allow a passage of grease.

14. Wheel arch according to any one of the claims 12-13, characterized in that
14a) the greasing means comprise, in the frame (2), a second greasing hole (22) configured to allow a passage of grease.

15. Wheel arch according to any one of the claims 12-14, characterized in that:
15a) the greasing means comprise, in the seat (3), a third greasing hole (32) configured to allow a passage of grease.

16. Wheel arch according to any one of the claims 1-15, characterized in that:
16a) the frame (2) is configured in the form of a leaf spring to provide shock-absorption by means of a controlled bending deformation of the frame (2).

17. Wheel comprising a plurality of wheel arches according to any one of the claims 1-16, characterized in that the arches are configured to make up a tread of the wheel.

18. Wheel according to claim 17, characterized in that:
18a) the tyre (4) comprises a tyre supplement (40) configured to define a location of a wheel arch on the tyre (4).

19. Wheel according to claim 18, characterized in that:
19a) the fixing means comprise, in a location selected between the tyre (4) and the tyre supplement (40), a fourth fixing hole (41), configured to allow a passage of a grip screw (101).

20. Wheel according to any one of the claims 18-19, characterized in that:
20a) the greasing means comprise, in a location selected between the tyre (4) and the tyre supplement (40), a fourth greasing hole (42), configured to allow a passage of grease.

21. Wheel according to any one of the claims 17-20, characterized in that it comprises:
21a) a closing element (100) configured to be coupled on two consecutive arches to collaborate with the fixing of the two arches on the tyre (4).

22. Wheel according to claim 21, characterized in that it comprises:
22a) positioning means (43) configured to constrain a relative movement between the closing element (100) and the tyre (4).

23. Wheel according to any one of the claims 21-22, characterized in that:
23a) the closing element (100) comprises a liner supplement (110) configured to provide continuity to the tread between the liners (1) of two consecutive arches.

24. Wheel according to any one of the claims 21-22, characterized in that:
24a) the fixing means comprise, in the closing element (100), a plurality of fifth fixing holes (51) configured to allow a passage of grip screws (101).

25. Wheel according to any one of the claims 17-24, characterized in that:
25a) the fixing means comprise a plurality of nuts (102) configured to thread with the grip screws (101) and fix components of the wheel to the tyre (4).

26. Wheel according to any one of the claims 19-25, characterized in that it comprises a plurality of caps (6) configured to prevent the contact of the grip screws (101) and the fixing holes (11, 21, 31, 41).

27. Wheel according to claim 26, characterized in that:
27a) it comprises a stopper sheet (5) configured to delimit a radial penetration of the caps (6) into the wheel;
27b) the fixing means comprise, in the stopper sheet, a fifth fixing hole (51) configured to allow a passage of a grip screw (101).

28. Wheel according to any one of the claims 20-26, characterized in that it comprises:
28a) a grease nipple (202) configured to supply grease through a greasing hole selected from the first greasing hole (12), the second greasing hole (22), the third greasing hole (32), the fourth greasing hole (42) and combinations thereof

29. Wheel according to any one of the claims 20-26, characterized in that it comprises retaining means (424) configured to be connected to a connecting ring (24) of the frame (2).
